(19) United States
(12) Patent Application Publication
(10) Pub. No.: US 2017/0120818 A1
(43) Pub. Date: May 4, 2017

(54) PARKING AUXILIARY SYSTEM AND PARKING METHOD

(71) Applicant: LEAUTO INTELLIGENT TECHNOLOGY (BEIJING) CO. LTD, Chaoyang District Beijing (CN)

(72) Inventors: Yu ZOU, Chaoyang District Beijing (CN); Yong XU, Chaoyang District Beijing (CN); Wenrui LI, Chaoyang District Beijing (CN); Kunsheng CHEN, Chaoyang District Beijing (CN); Dan LI, Chaoyang District Beijing (CN); Wei LIN, Chaoyang District Beijing (CN); Peng LIU, Chaoyang District Beijing (CN)

(21) Appl. No.: 14/978,749

(22) Filed: Dec. 22, 2015

(30) Foreign Application Priority Data
Oct. 29, 2015 (CN) 2015107171960

(51) Int. Cl. B60R 1/00

(52) U.S. Cl. CPC B60R 1/00; B60R 2300/806

(57) ABSTRACT

The present disclosure provides a parking auxiliary system and a parking method. Wherein the system comprise: a communication module, an image collection module, and an image processing module; The present disclosure achieves real-time image transmission, so that a driver can park according to the transmitted images, without need of image stitching, which is of low cost and easy to implement.

### CROSS-REFERENCE TO RELATED APPLICATIONS

This application is based upon and claims priority to Chinese Patent Application No. 201510717196.0, titled “parking auxiliary system and a parking method”, filed on Oct. 29, 2015, the entire contents of which are incorporated herein by reference.

### FIELD OF TECHNOLOGY

The present disclosure generally relates to a technical field of vehicle technology, and more particularly to a parking auxiliary system and a parking method.

### BACKGROUND

Currently vehicle visual auxiliary system mainly adopts a rear-view camera, that is, installing a rear-view camera in a vehicle, when the vehicle backs up, a driver is provided with a clear back view image to resolve visual blind spot.

Meanwhile more and more vehicles are equipped with 360° panorama parking system, and its main implementation mode is to install four fisheye cameras in the front, back, left and right of the vehicles respectively, and gather and stitch camera images to achieve a panorama view, provided for the driver as visual parking auxiliary.

Aforesaid visual parking system is based on the vehicle itself, and the vehicle needs to be equipped with a complete set of the system, and meanwhile is limited by the installing position of the camera. The view of visual stitching has its limitation, and the requirement and cost for implementing the technology are relatively high.

### SUMMARY

In view of aforesaid problem, the present disclosure provides a parking auxiliary system and a parking method, so that a driver can park according to an image transmitted by the parking auxiliary system.

According to one aspect of the present disclosure, a parking auxiliary system, and the system comprises:

one or more processors; and

a memory;

wherein one or more programs are stored in the memory, and when executed by the one or more processors, the one or more programs cause the one or more processors to perform:

receiving a short message set sent by a vehicle, and sending a starting signal according to said short message set;

collecting images of the vehicle driven into a garage according to said starting signal;

rectifying and compressing said images, and transmitting processed images to said vehicle, allowing said vehicle to park according to the processed images.

Optionally, the one or more processors are further configured to perform:

matching said vehicle identity information with preset vehicle identity information to judge whether the vehicle belongs to the garage or not, and if yes, sending the starting signal.

Optionally, the one or more processors are further configured to perform:

sending a closing signal if the short message set sent by the vehicle is not received within a preset time;

stopping collecting images according to said closing signal.

Optionally, the one or more processors are further configured to perform:

receiving the short message set sent by the vehicle via a V2X wireless communication mode.

Optionally, said short message set is a dedicated short-range communication short message set, comprising: longitude, latitude, and driving direction of a vehicle.

According to another aspect of the present disclosure, a parking method is provided, and the method includes:

receiving a short message set sent by a vehicle, and sending a starting signal according to the short message set;

collecting images of the vehicle driven into a garage according to the starting signal;

rectifying and compressing the images, and transmitting processed images to the vehicle, allowing the vehicle to park according to the processed images.

Optionally, the short message set carries vehicle identity information;

The method further includes: matching the vehicle identity information with preset vehicle identity information to judge whether the vehicle belongs to the garage or not, if yes, sending the starting signal

Optionally, the method further includes:

sending a closing signal if the short message set sent by the vehicle is not received within a preset time.

Optionally, receiving a short message set sent by a vehicle further includes:

receiving the short message set sent by the vehicle via a V2X wireless communication mode.

Optionally, the short message set is a dedicated short-range communication short message set, comprising: longitude, latitude, and driving direction of a vehicle.

According to the scheme provided by the present disclosure, the communication module receives the short message set sent by the vehicle, and sends the starting signal to the image collection module according to the short message set; the image collection module collects the images of the vehicle driven into the garage according to the starting signal, and transmits the images to the image processing module; the image processing module rectifies and compresses the images, and transmits the processed images to the communication module; and the communication module receives the processed images transmitted by the image processing module, and sends the processed images to the vehicle for the vehicle to park according to the processed images. The scheme achieves real-time image transmission, so that the driver can park the vehicle according to the transmitted images, without need of image stitching, which is of low cost and easy to implement.

Above description is only a summary of the technical scheme of the present disclosure. In order to know the technical means of the present disclosure more clearly so that it can be put into effect according to the content of the description, and to make the aforesaid and other purpose, features and advantages of the present disclosure clearer, the embodiments of the present disclosure will be described in further detail with reference to the drawings.

### BRIEF DESCRIPTION OF THE DRAWINGS

One of ordinary skill in this art will appreciate other advantages from the following detailed description of exemplary embodiments herein. Drawings are only for showing exemplary embodiments but not for limiting the scope of the present disclosure. Through the drawings, similar reference numbers represent similar elements.

FIG. 1 is a structure diagram of a parking auxiliary system according to an embodiment of the present disclosure;

FIG. 2 is a structure diagram of a parking auxiliary system according to another embodiment of the present disclosure;

FIG. 3 is a flowchart showing a parking method according to an embodiment of the present disclosure;

FIG. 4 is a flowchart showing a parking method according to another embodiment of the present disclosure;

FIG. 5 is a structure diagram of a parking auxiliary system according to an embodiment of the present disclosure.

### DESCRIPTION OF THE EMBODIMENTS

Exemplary embodiments of the present disclosure will be described below in detail with reference to drawings. Even though exemplary embodiments of the present disclosure are presented in drawings, it shall be appreciated that the present disclosure may be practiced in various manners without being limited to the embodiments set forth herein. Instead, the embodiments are provided herein to make the present disclosure be understood more thoroughly and to more completely convey the scope of the present disclosure to one of ordinary skill in this art.

The parking auxiliary system of the present disclosure can be applied to a garage. When a vehicle is driven into the garage, the parking auxiliary system can be configured to guide a driver to park the vehicle.

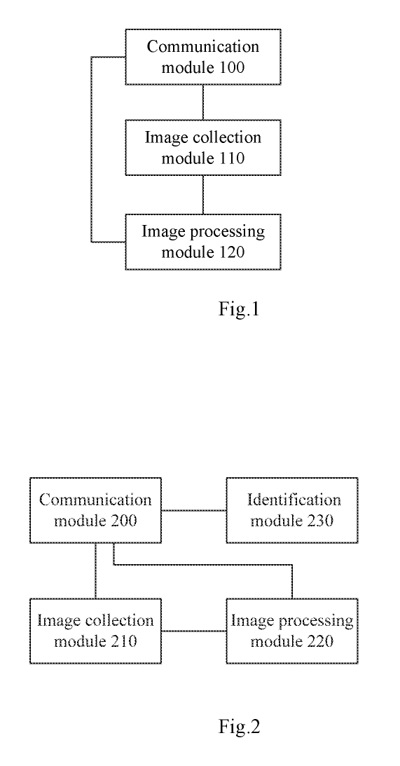

FIG. 1 is a structure diagram of a parking auxiliary system according to an embodiment of the present disclosure. As is shown in FIG. 1, the system includes: a communication module 100, an image collection module 110, and an image processing module 120.

The communication module 100 is configured to receive a short message set sent by a vehicle, and to send a starting signal to the image collection module according to the short message set.

Specifically, when the vehicle is driven into a garage, the short message set is sent to the communication module 100 of the parking auxiliary system. The communication module 100 receives the short message set, knowing that a vehicle will be driven into the garage, and sends the starting signal to the image collection module 110. The starting signal is for making the image collection module 110 into a working state to collect images.

The image collection module 110 is configured to collect the image of the vehicle driven into a garage according to the starting signal, and to transmit the images to the image processing module.

Specifically, the image collection module 110 receives the starting signal sent by the communication module 100, and then starts to collect images, collecting all the images of the vehicle entering into the garage through the gate of the garage and transmit collected images to the image processing module 120.

The image processing module 120 is configured to rectify and compress said images, and to transmit the processed images to the communication module.

The images collected by the image collection module might result in image distortion owing to various reasons, such as image distortion caused by aberration, distortion and limited bandwidth of the image collection module; image distortion as a result of filming posture and nonlinear scanning of the image collection module; and image distortion caused by motion blur, radiation distortion, and introduction of noise.

Specifically, the image processing module 120 receives the images transmitted by the image collection module, and then rectifies the images, which specifically refers to performing restoration process on the distorted images to obtain real images.

After the images are rectified, the rectified images are compressed to reduce image data and decrease image byte, and then the compressed images are transmitted to the communication module 100.

The communication module 100 is further configured to receive the processed images transmitted by the image processing module, and to send the processed images to the vehicle, allowing the vehicle to park according to the processed images.

Specifically, after receiving the compressed images, the communication module 100 sends the images to the vehicle. After receiving the images, the vehicle decompresses and displays them, so as to provide visualized parking auxiliary images for the driver.

According to the system provided by aforesaid embodiment of the present disclosure, the communication module receives the short message set sent by the vehicle, and sends the starting signal to the image collection module according to the short message set; the image collection module collects the images of the vehicle driven into the garage according to the starting signal, and transmits the images to the image processing module; the image processing module rectifies and compresses the images, and transmits the processed images to the communication module; and the communication module receives the processed images transmitted by the image processing module, and sends the processed images to the vehicle for the vehicle to park according to the processed images. The system achieves real-time image transmission, so that the driver can park the vehicle according to the transmitted images, without need of image stitching, which is of low cost and easy to implement.

FIG. 2 is a structure diagram of a parking auxiliary system according to another embodiment of the present disclosure. As is shown in FIG. 2, the system includes: a communication module 200, an image collection module 210, an image processing module 220, and an identification module 230.

The communication module 200 is configured to receive a short message set sent by a vehicle, and to send a starting signal to the image collection module according to the short message set.

The communication module 200 is V2X wireless communication module. V2X (Vehicle-to-X) refers to communication between the vehicle and peripheral equipments. X includes vehicles, roadside units, service stations, etc. Currently a wireless communication technology accords with IEEE802.11P protocol, and a designed transmission distance is 300-1000 m, and transmission rate is 3M-27 Mbps. It can be applied to a field of intelligent transportation and active safety of driving. V2X wireless communication has advantages of high instantaneity of transmission, no need of base station, and without problems of operator traffic and fee.

The short message set is a dedicated short-range communication short message set (DSRC short message set), comprising: longitude, latitude, and driving direction of a vehicle. Position of the vehicle can be accurately calculated according to the longitude and latitude of the vehicle. The driving direction is for instructing the vehicle to drive into or drive out of the garage. After receiving the short message sent by the vehicle, the communication module can confirm the position of the vehicle according to the longitude and latitude of the vehicle, and thereby determine whether to collect the images or not.

Specifically, when the vehicle is driven into the garage, the short message set can be sent to the communication module 200 of the parking auxiliary system via the V2X wireless communication module of the vehicle itself. The communication module 200 receives the short message set, knowing that the vehicle will be driven into the garage, and sends the starting signal to the image collection module 210. The starting signal is for making the image collection module into a working state to collect images.

The image collection module 210 is configured to collect the images of the vehicle driven into a garage according to the starting signal, and to transmit the images to the image processing module.

Specifically, after receiving the starting signal sent by the communication module, the image collection module 210 starts to collect images, collecting all the images of the vehicle entering into the garage through the gate of the garage and transmit the collected images to the image processing module.

The image collection module is a fisheye image collection module, for example, a fisheye camera, which can be installed on the top of the garage and can independently achieve wide-range monitoring without blind corner to satisfy the driver's need of parking.

The image processing module 220 is configured to rectify and compress said images, and to transmit the processed images to the communication module.

The images collected by the image collection module might result in image distortion owing to various reasons, such as image distortion caused by aberration, distortion and limited bandwidth of the image collection module; image distortion as a result of filming posture and nonlinear scanning of the image collection module; and image distortion caused by motion blur, radiation distortion, and introduction of noise.

Specifically, after receiving the images transmitted by the image collection module, the image processing module 220 will rectify the images, which specifically refers to performing restoration process on the distorted images to obtain real images.

When the fisheye camera is adopted to collect the images, the process performed by the image processing module on the images is mainly fisheye rectification.

After the images are rectified, the rectified images are compressed to reduce image data and decrease image byte, and then the compressed images are transmitted to the communication module.

The communication module 200 is further configured to receive the processed images transmitted by the image processing module, and to send the processed images to the vehicle, allowing the vehicle to park according to the processed images.

Specifically, after receiving the compressed images, the communication module will send the images to the vehicle. After receiving the images, the vehicle decompresses and displays them, so as to provide visualized parking auxiliary images for the driver.

In the present embodiment, the short message set carries vehicle identity information;

The system further includes: an identification module 230, configured to receive the short message set which carries the vehicle identity information sent by the communication module, and to match the vehicle identity information with the preset vehicle identity information to judge whether the vehicle belongs to the garage or not, if yes, to send the starting signal to the image collection module via the communication module.

The vehicle identity information can be license plate number or a vehicle identification of the vehicle, and the license plate number or the vehicle identification of each vehicle is unique.

Specifically, after receiving the short message set which carries the vehicle identity information sent by the vehicle, the communication module will send the short message set to the identification module 230. After receiving the short message set which carries the vehicle identity information, the identification module will match the vehicle identity information with the preset vehicle identity information to judge whether the vehicle belongs to the garage or not, and if yes, it will send the starting signal to the image collection module via the communication module, thus avoid wrongly receiving a short message set sent by a vehicle of other garages and starting the image collection module to collect images, causing waste of resources.

In addition, in order to save resources and avoid unnecessary waster, the communication module 200 is further configured to send a closing signal to the image collection module if the short message set sent by the vehicle is not received within a preset time.

The image collection module is further configured to stop collecting images according to the closing signal sent by the communication module.

Specifically, when the vehicle has left the garage or the vehicle has parked in the garage and is extinct, the vehicle will not send the short message set to the communication module. If the communication module does not receive the short message set sent by the vehicle within the preset time, for example, 3 minutes, it will send the closing signal to the image collection module. The image collection module will stop collecting images after receiving the closing signal.

According to the system provided by aforesaid embodiment of the present disclosure, the communication module receives the short message set sent by the vehicle, and sends the starting signal to the image collection module according to the short message set; the image collection module collects the images of the vehicle driven into the garage according to the starting signal, and transmits the images to the image processing module; the image processing module rectifies and compresses the images, and transmits the processed images to the communication module; and the communication module receives the processed images transmitted by the image processing module, and sends the processed images to the vehicle for the vehicle to park according to the processed images. The system achieves real-time image transmission, so that the driver can park the vehicle according to the transmitted images, without need of image stitching, which is of low cost and easy to implement. The identification module receives the short message set which carries the vehicle identity information sent by the communication module, and then matches the vehicle identity information with the preset vehicle identity information to judge whether the vehicle belongs to the garage or not, and if yes, it will send the starting signal to the image collection module via the communication module, thus avoids wrongly receiving a short message set sent by a vehicle of other garages and starting the image collection module to collect images, causing waste of resources.

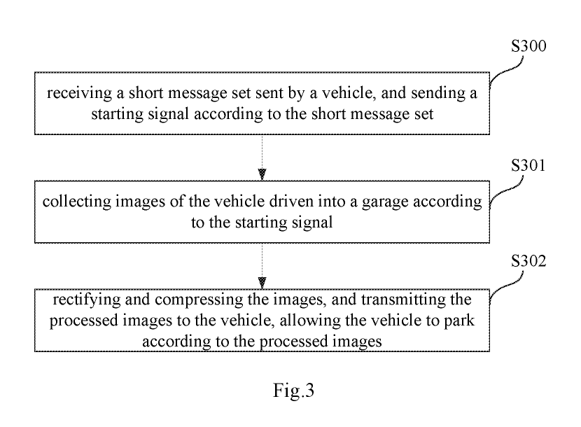

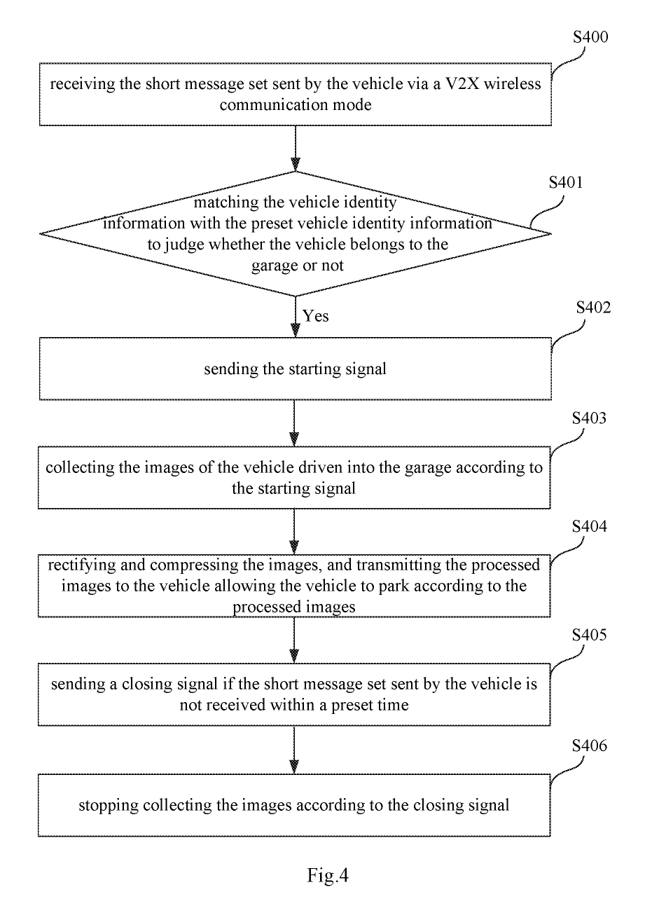

FIG. 3 is a flowchart showing a parking method according to an embodiment of the present disclosure. As is shown in FIG. 3, the method includes the following steps:

Step S300, receiving a short message set sent by a vehicle, and sending a starting signal according to the short message set.

Specifically, when the vehicle is driven into a garage, the short message set is sent to the communication module of the parking auxiliary system. The communication module receives the short message set, knowing that a vehicle will be driven into the garage, and sends the starting signal to the image collection module. The starting signal is for making the image collection module into a working state to collect images.

Step S301, collecting images of the vehicle driven into a garage according to the starting signal.

Specifically, the image collection module receives the starting signal sent by the communication module, and then starts to collect images, collecting all the images of the vehicle entering into the garage through the gate of the garage and transmit the collected images to the image processing module.

Step S302, rectifying and compressing the images, and transmitting the processed images to the vehicle, allowing the vehicle to park according to the processed images.

The images collected by the image collection module might result in image distortion owing to various reasons, such as image distortion caused by aberration, distortion and limited bandwidth of the image collection module; image distortion as a result of filming posture and nonlinear scanning of the image collection module; and image distortion caused by motion blur, radiation distortion, and introduction of noise.

Specifically, the image processing module receives the images transmitted by the image collection module, and then rectifies the images, which specifically refers to performing restoration process on the distorted images to obtain real images.

After the images are rectified, the rectified images are compressed to reduce image data and decrease image byte, and then the compressed images will be transmitted to the communication module.

After receiving the compressed images, the communication module sends the images to the vehicle. After receiving the images, the vehicle decompresses and displays them, so as to provide visualized parking auxiliary images for the driver.

According to the method provided by aforesaid embodiment of the present disclosure, receiving the short message set sent by the vehicle, and sending the starting signal to the image collection module according to the short message set, collecting the images of the vehicle driven into the garage according to the starting signal, rectifying and compressing the images, and sending the processed images to the vehicle, for the vehicle to park according to the processed images achieves real-time image transmission, so that the driver can park the vehicle according to the transmitted images, without need of image stitching, which is of low cost and easy to implement.

FIG. 4 is a flowchart showing a parking method according to another embodiment of the present disclosure. As is shown in FIG. 4, the method includes the following steps:

Step S400, receiving the short message set sent by the vehicle via a V2X wireless communication mode.

V2X (Vehicle-to-X) refers to communication between the vehicle and peripheral equipments. X includes vehicles, roadside units, service stations, etc. Currently a wireless communication technology accords with IEEE802.11P protocol, and a designed transmission distance is 300-1000 m, and transmission rate is 3M-27 Mbps. It can be applied to a field of intelligent transportation and active safety of driving. V2X wireless communication has advantages of high instantaneity of transmission, no need of base station, and without problems of operator traffic and fee.

The short message set is a dedicated short-range communication short message set (DSRC short message set), comprising: longitude, latitude, and driving direction of a vehicle. Position of the vehicle can be accurately calculated according to the longitude and latitude of the vehicle. The driving direction is for instructing the vehicle to drive into or drive out of the garage. After receiving the short message sent by the vehicle, the communication module can confirm the position of the vehicle according to the longitude and latitude of the vehicle, and thereby determine whether to collect the images or not.

The short message set carries vehicle identity information.

Specifically, when the vehicle is driven into the garage, the short message set can be sent to the communication module of the parking auxiliary system via the V2X wireless communication module of the vehicle itself. The communication module receives the short message set, and sends the short message set carries vehicle identity information to the identification module.

Step S401, matching the vehicle identity information with the preset vehicle identity information to judge whether the vehicle belongs to the garage or not, if yes, executing Step S402, and if not, ending the method.

After receiving the short message set which carries the vehicle identity information, the communication module will match the vehicle identity information with the preset vehicle identity information to judge whether the vehicle belongs to the garage or not, and if yes, it will send the starting signal to the image collection module via the communication module, thus avoid wrongly receiving a short message set sent by a vehicle of other garages and starting the image collection module to collect images, causing waste of resources.

Step S402, sending the starting signal.

Step S403, collecting the images of the vehicle driven into the garage according to the starting signal.

Specifically, after receiving the starting signal sent by the communication module, the image collection module starts to collect images, collecting all the images of the vehicle entering into the garage through the gate of the garage and transmit the collected images to the image processing module.

For example, a fisheye camera can be configured to collect the images, and the fisheye camera can be installed on the top of the garage and can independently achieve wide-range monitoring without blind corner to satisfy the driver's need of parking.

Step S404, rectifying and compressing the images, and transmitting the processed images to the vehicle allowing the vehicle to park according to the processed images.

The images collected by the image collection module might result in image distortion owing to various reasons, such as image distortion caused by aberration, distortion and limited bandwidth of the image collection module; image distortion as a result of filming posture and nonlinear scanning of the image collection module; and image distortion caused by motion blur, radiation distortion, and introduction of noise.

Specifically, after receiving the images transmitted by the image collection module, the image processing module will rectify the images, which specifically refers to performing restoration process on the distorted images to obtain real images.

When the fisheye camera is adopted to collect the images, the process performed by the image processing module on the images is mainly fisheye rectification.

After the images are rectified, the rectified images are compressed to reduce image data and decrease image byte, and then the compressed images are transmitted to the communication module.

Specifically, after receiving the compressed images, the communication module will send the images to the vehicle. After receiving the images, the vehicle decompresses and displays them, so as to provide visualized parking auxiliary images for the driver.

Step S405, sending a closing signal if the short message set sent by the vehicle is not received within a preset time.

Step S406, stopping collecting the images according to the closing signal.

Specifically, when the vehicle has left the garage or the vehicle has parked in the garage and is extinct, the vehicle will not send the short message set to the communication module. If the communication module does not receive the short message set sent by the vehicle within a preset time, for example, 3 minutes, it will send the closing signal to the image collection module. The image collection module will stop collecting images after receiving the closing signal.

According to the method provided by aforesaid embodiment of the present disclosure, the communication module receives the short message set sent by the vehicle, and sends the starting signal to the image collection module according to the short message set; the image collection module collects the images of the vehicle driven into the garage according to the starting signal, and transmits the images to the image processing module; the image processing module rectifies and compresses the images, and transmits the processed images to the communication module; and the communication module receives the processed images transmitted by the image processing module, and sends the processed images to the vehicle for the vehicle to park according to the processed images. The method achieves real-time image transmission, so that the driver can park the vehicle according to the transmitted images, without need of image stitching, which is of low cost and easy to implement. The identification module receives the short message set which carries the vehicle identity information sent by the communication module, and then matches the vehicle identity information with the preset vehicle identity information to judge whether the vehicle belongs to the garage or not, and if yes, it will send the starting signal to the image collection module via the communication module, thus avoids wrongly receiving a short message set sent by a vehicle of other garages and starting the image collection module to collect images, causing waste of resources.

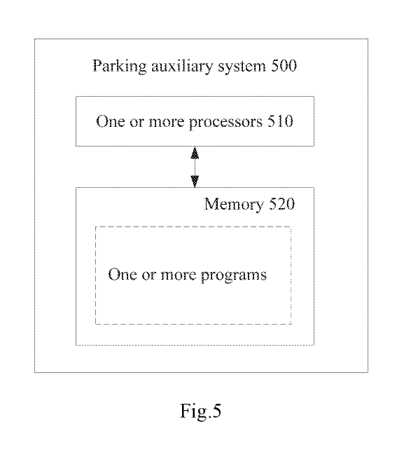

FIG. 5 is a structure diagram of a parking auxiliary system according to an embodiment of the present disclosure. As is shown in FIG. 5, the system 500 includes: one or more processors 510, and a memory 520; wherein one or more programs are stored in the memory, and when executed by the one or more processors, the one or more programs cause the one or more processors to perform:

receiving a short message set sent by a vehicle, and sending a starting signal according to said short message set;

collecting images of the vehicle driven into a garage according to said starting signal;

rectifying and compressing said images, and transmitting processed images to said vehicle, allowing said vehicle to park according to the processed images.

The above description has presented and illustrated many exemplary embodiments of the present disclosure, and however, as stated above, it shall be appreciated that the present disclosure is not limited to the implementations disclosed herein, providing these exemplary embodiments shall not be deemed as excluding other embodiments. Instead, the technical solutions in the present disclosure may be applied in any other combinations, variations and environments, and may be modified based on the above teaching or technologies or knowledge in related fields within the conceiving scope of the present disclosure. Any modifications or changes performed by one of ordinary skill in this art without departing from the spirit and scope of the present disclosure shall fall within the protection scope as defined by appended claims.

1. A parking auxiliary system, comprising:
one or more processors; and
a memory;
wherein one or more programs are stored in the memory, and when executed by the one or more processors, the one or more programs cause the one or more processors to perform:
receiving a short message set sent by a vehicle, and sending a starting signal according to said short message set;
collecting images of the vehicle driven into a garage according to said starting signal;
rectifying and compressing said images, and transmitting processed images to said vehicle, allowing said vehicle to park according to the processed images.

2. The parking auxiliary system according to claim 1, wherein the one or more processors are further configured to perform:
matching said vehicle identity information with preset vehicle identity information to judge whether the vehicle belongs to the garage or not, and if yes, sending the starting signal.

3. The parking auxiliary system according to claim 1, wherein the one or more processors are further configured to perform:
sending a closing signal if the short message set sent by the vehicle is not received within a preset time;
stopping collecting images according to said closing signal.

4. The parking auxiliary system according to claim 1, wherein the one or more processors are further configured to perform:
receiving the short message set sent by the vehicle via a V2X wireless communication mode.

5. The parking auxiliary system according to claim 1, wherein said short message set is a dedicated short-range communication short message set, comprising: longitude, latitude, and driving direction of a vehicle.

6. A parking method, comprising:
receiving a short message set sent by a vehicle, and sending a starting signal according to said short message set;
collecting images of the vehicle driven into a garage according to said starting signal;
rectifying and compressing said images, and transmitting processed images to said vehicle, allowing said vehicle to park according to the processed images.

7. The parking method according to claim 6, wherein said short message set carries vehicle identity information;
said method further comprises: matching said vehicle identity information with preset vehicle identity information to judge whether the vehicle belongs to the garage or not, and if yes, sending the starting signal.

8. The parking method according to claim 6, wherein said method further comprises:
sending a closing signal if the short message set sent by the vehicle is not received within a preset time;
stopping collecting images according to said closing signal.

9. The parking method according to claim 6, wherein said receiving a short message set sent by a vehicle further comprises:
receiving the short message set sent by the vehicle via a V2X wireless communication mode.

10. The parking method according to claim 6, wherein said short message set is a dedicated short-range communication short message set, comprising: longitude, latitude, and driving direction of a vehicle.
